(19) United States
(12) Patent Application Publication
(10) Pub. No.: US 2021/0318976 A1
(43) Pub. Date: Oct. 14, 2021

(54) CHASSIS, CHASSIS MONITORING SYSTEM, AND CHASSIS MONITORING METHOD

(71) Applicant: Celestica Technology Consultancy (Shanghai) Co. Ltd, Shanghai (CN)

(72) Inventors: Kayeh ZHANG, Shanghai (CN); Kun YANG, Shanghai (CN)

(73) Assignee: Celestica Technology Consultancy (Shanghai) Co. Ltd, Shanghai (CN)

(21) Appl. No.: 17/227,389

(22) Filed: Apr. 12, 2021

(30) Foreign Application Priority Data
Apr. 13, 2020 (CN) 2020102866080

(51) Int. Cl. G06F 13/40; G06F 13/42

(52) U.S. Cl. CPC G06F 13/4027; G06F 2213/0036; G06F 2213/0026; G06F 13/4282

(57) ABSTRACT

The present disclosure provides a chassis, a chassis monitoring system, and a chassis monitoring method. The chassis includes: at least one PCIe device; a PCIe switch including an upstream bridge port for connecting with a host of an electronic device and at least one downstream bridge port for connecting with the PCIe device; a virtual endpoint, configured in the PCIe switch, for receiving the SES instruction sent by the host, causing the firmware in the PCIe switch to execute the SES instruction, and feeding back an execution result to the host after the firmware in the PCIe switch generates the execution result according to the SES instruction, the host monitors the chassis according to the execution result.

### CROSS REFERENCES TO RELATED APPLICATION

This application claims the benefits of priority to Chinese Patent Application No. CN 2020102866080 filed on Apr. 13, 2020, entitled “Chassis, Chassis Monitoring System and Chassis Monitoring Method”, the contents of which are incorporated herein by reference in its entirety.

### TECHNICAL FIELD

The present disclosure relates to the technical field of servers, in particular, to the technical field of chassis.

### BACKGROUND

Peripheral Component Interconnect-Express (PCIe) is a high-speed serial computer expansion bus standard with the original name “3GIO”. It was proposed by Intel in 2001 to replace the old PCI, PCI-X and Accelerated Graphics Port (AGP) bus standards. PCIe is a high-speed serial point-to-point dual-channel high-bandwidth transmission standard in which connected devices are allocated exclusive channel bandwidth and do not share bus bandwidth. PCIe supports functions like active power management, error reporting, end-to-end reliable transmission, hot plug, and quality of service (QOS).

As the use of PCIe bus expands from the board-level bus to the rack-level bus, PCIe switches have started to be used in the chassis alone. This type of chassis can be used to expand the computing, storage, graphics processing, and network processing capabilities of the entire system. The conventional SCSI Enclosure Service (SES) technology is based on Small Computer System Interface (SCSI) and Serial Attached SCSI (SAS) link transmission to monitor and manage the interface of the Just a Bunch Of Disks (JBOD) chassis, and is not applicable to management of chassis containing PCIe devices (such as PCIe SSD). Existing chassis monitoring and management are all out-of-band monitoring based on Baseboard Management Controller (BMC). However, BMC has certain limitations in terms of PCIe SSD monitoring and management, which increases hardware costs. Native PCIe enclosure management can solve the problem of PCIe SSD management, but it needs hardware circuit support and its functions are limited to the management of PCIe SSD lights.

### SUMMARY

The present disclosure provides a chassis, chassis monitoring system and chassis monitoring method to solve problems relating to monitoring and managing a chassis with PCIe devices.

The present disclosure provides a chassis communicating with an electronic device through a PCIe link, and the chassis includes: at least one PCIe device; a PCIe switch including an upstream bridge port for connecting with a host of an electronic device and a downstream bridge port for connecting with the at least one PCIe device; a virtual endpoint, configured in the PCIe switch, for receiving an SES instruction sent by the host, causing the firmware in the PCIe switch to execute the SES instructions, and feeding back an execution result to the host after the firmware in the PCIe switch generates the execution result according to the SES instruction, the host monitors the chassis according to the execution result.

In an embodiment of the present disclosure, after the firmware in the PCIe switch generates the execution result according to the SES instruction, the virtual endpoint sends an event notification for notifying that the execution result has been generated to the host, after receiving the event notification, the host sends a read instruction to the virtual endpoint, and the virtual endpoint feeds back the execution result of the PCIe switch firmware to the host.

In an embodiment of the present disclosure, the PCIe switch executes the SES instruction through a management thread created by the firmware.

In an embodiment of the present disclosure, regarding the communication between the PCIe switch and the host, when the host of the electronic device starts, the virtual endpoints in the PCIe switch are discovered in a PCIe standard enumeration process, so that the host sends the SES instruction to the virtual endpoint.

In an embodiment of the present disclosure, the PCIe device includes a PCIe SSD, a PCIe GPU card, a PCIe NIC card, or a PCIe switch.

In an embodiment of the present disclosure, the virtual endpoint further receives a designated instruction sent by the host to cause the firmware in the PCIe switch execute the designated instruction, and feeds back an execution result to the host after the firmware in the PCIe switch generates the execution result according to the designated instruction, so that the host obtain a designated information of the chassis or the PCIe switch according to the execution result.

The present disclosure also provides a chassis monitoring system, and the chassis monitoring system includes: the chassis as described above; and an electronic device, communicating with the chassis through a PCIe link, sending an SES instruction to the virtual endpoint, obtaining an execution result of the SES instruction through the virtual endpoint, and monitoring the chassis according to the execution result.

In an embodiment of the present disclosure, the electronic device displays the execution result for monitoring the chassis.

The present disclosure also provides a chassis monitoring method, and the chassis monitoring method includes: configuring a PCIe switch, at least one PCIe device, and a virtual endpoint in the chassis; sending, by a host of the electronic device, an SES instruction to the virtual endpoint in the chassis; causing, by the virtual endpoint, the firmware in the PCIe switch in the chassis to execute the SES instruction, and feeding back an execution result to the host after the firmware in the PCIe switch generates the execution result according to the SES instruction, so that the host monitors the chassis according to the execution result.

In an embodiment of the present disclosure, the feeding back of the execution result to the host includes: after the firmware in the PCIe switch generates the execution result according to the SES instruction, the virtual endpoint sends an event notification for notifying that the execution result has been generated to the host; after receiving the event notification, the host sends a read instruction to the virtual endpoint; the virtual endpoint feeds back the execution result of the PCIe switch firmware to the host.

As mentioned above, the chassis, chassis monitoring system, and chassis monitoring method of the present disclosure have the following beneficial effects:

1. In the present disclosure, a virtual EP is configured in the PCIe switch in the chassis. Based on this virtual EP, the electronic device transmits SES instructions to the PCIe switch in the chassis through the PCIe link to monitor the chassis and obtain the monitoring result.

2. According to the present disclosure, as long as SES-over-PCIe services can be implemented on the firmware of PCIe switches, complete SES service can be provided in electronic devices of any form (servers, personal computers, data centers, etc.), which greatly reduces the hardware cost for monitoring and managing the chassis, and greatly improved the efficiency and operation convenience of the chassis.

### BRIEF DESCRIPTION OF THE DRAWINGS

FIG. 1 is an overall structure diagram of a chassis monitoring system in an embodiment of the present disclosure.

FIG. 2 is an overall structure diagram of a PCIe switch in an embodiment of the present disclosure.

FIG. 3 shows a schematic flowchart of a chassis monitoring method in an embodiment of the present disclosure.

### LIST OF REFERENCE NUMERALS

100 Chassis
110 PCIe switch
111 Virtual endpoint
112 Upstream bridge port
113 Downstream bridge port
120 PCIe device
200 Electronic device
210 Host
S100-S300 Steps

### DETAILED DESCRIPTION OF THE PREFERRED EMBODIMENTS

The present application is described through the following specific examples, and those skilled in the art can easily understand other advantages and effects of the present disclosure from the content disclosed in this specification. The present disclosure can also be implemented or applied through other different specific embodiments, and various details in this specification can also be modified or changed based on different viewpoints and applications without departing from the spirit of the present disclosure.

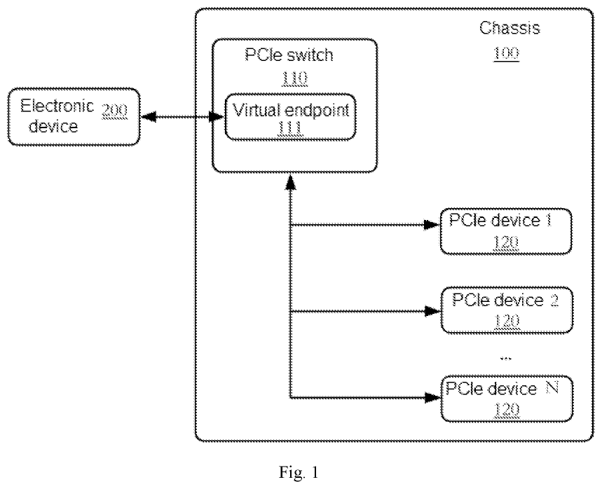

Please refer to FIGS. 1 to 3. It should be noted that the structure, ratio, size, etc. shown in the accompanying drawings in this specification are only used to illustrate the content disclosed in the specification for the understanding and reading of those familiar with this technology, and are not intended to limit the implementation of the present disclosure. Any structural modification, proportional relationship change or size adjustment without affecting the effects and objectives of the present disclosure should still fall in the scope of the present disclosure. At the same time, the terms such as “upper”, “lower”, “left”, “right”, “middle” and “a”, “an” quoted in this specification are only for the convenience of description and are not used to limit the scope of implementation of the disclosure, and any adjustment of the relative relationship described herein without substantial changes to the technical content shall be regarded as within the scope of implementation of the disclosure.

The present disclosure provides a chassis, a chassis monitoring system and a chassis monitoring method to solve problems relating to monitoring and managing a chassis with PCIe devices.

The present disclosure provides a chassis, chassis monitoring system and a chassis monitoring method. According to the present disclosure, as long as SES-over-PCIe services can be implemented on the firmware of PCIe switches, complete SES services can be provided in any form of electronic devices (servers, personal computers, data centers, etc.), which greatly reduces the hardware cost for monitoring and managing the chassis, and greatly improved the efficiency and operation convenience of the chassis.

The following will elaborate on the principle and implementation of the chassis, chassis monitoring system and chassis monitoring method, so that those skilled in the art can understand them without creative work.

### Embodiment 1

As shown in FIG. 1, this embodiment provides a chassis monitoring system. The chassis monitoring system includes: an electronic device 200 (such as server, controller) and a chassis 100.

In this embodiment, the electronic device 200 communicates with the chassis 100 through a PCIe link, and sends an SES instruction to the chassis 100 to monitor the chassis 100.

The electronic device 200 may be a personal computer that includes a memory, a storage controller, one or more processors, a peripheral interface, an RF circuit, an audio circuit, a speaker, a microphone, an input/output (I/O) subsystem, a display screen, other output or control devices, and external ports. The personal computer is not limited to desktop computers, notebook computers, tablet computers, smart phones, smart TVs, personal digital assistants (PDA) and other personal computers. In other embodiments, the electronic device 200 may be a server or a data center. The server may be one or more physical servers arranged according to various factors such as functionalities and load, and may also comprise a distributed or centralized server cluster.

The memory of the electronic device 200 may include a random access memory (RAM), and may further include a non-volatile memory, for example, at least one disk memory.

The processors in the present application may include a general-purpose processor, including a CPU, a network processor (NP), etc. The processors may also include a digital signal processor (DSP), application specific integrated circuit (ASIC), field-programmable gate array (FPGA) or other programmable logic devices, discrete gate or transistor logic device, discrete hardware components.

In this embodiment, the chassis 100 includes a PCIe switch 110, and at least one PCIe device 120 (e.g., PCIe device 1, PCIe device 2, . . . , PCIe device N as shown in FIG. 1) coupled to the PCIe switch 110, and a virtual endpoint 111 (EP) configured in the PCIe switch 110.

The PCIe switch 110 can be coupled with a PCIe device 120 with any function. The PCIe device 120 may be a PCIe SSD, a PCIe GPU card, a PCIe NIC card, or a PCIe switch.

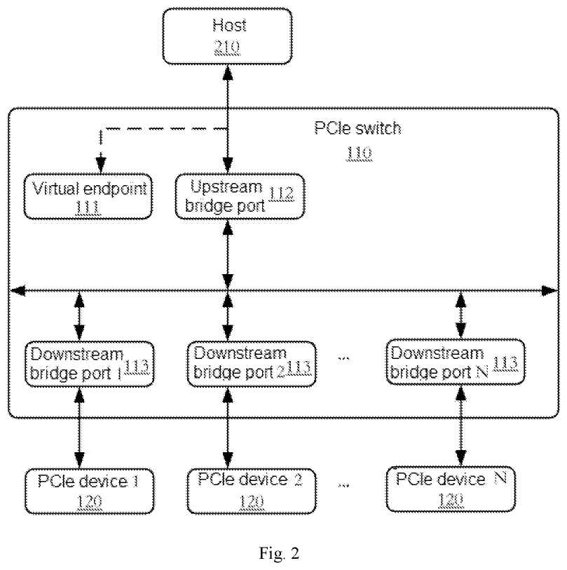

In this embodiment, as shown in FIG. 2, the PCIe switch 110 include a PCI-to-PCI Bridge (P2P) for connecting with upstream ports and a plurality of P2Ps for connecting with downstream ports. That is, the PCIe switch 110 includes an upstream bridge port 112 (P2P) for connecting with the host 210 of the electronic device 200 and at least one downstream bridge port 113 (P2P) (downstream bridge port 1, downstream bridge port 2, . . . , downstream bridge port N shown in FIG. 2) for connecting with the PCIe device 120.

In this embodiment, the upstream bridge port 112 is connected with the host 210 of the electronic device 200, and the downstream bridge port 113 is connected with the PCIe device 120. When the PCIe device 120 is a PCIe switch 110, the downstream port may also be used as an expansion port for cascading multiple PCIe switches 110, so as to obtain a larger PCIe topology structure. When the chassis 100 of the PCIe switches 110 are cascaded, the host 210 of the electronic device 200 needs sufficient memory resources.

The electronic device 200 transmits the SES instruction to the PCIe switch 110 through the PCIe communication protocol, and the firmware in the PCIe switch 110 executes the SES instruction to monitor the chassis 100. The PCIe switch 110 transmits the execution result of the SES instruction to the electronic device 200.

In order for the electronic device 200 to monitor the chassis 100 by, the PCIe switch 110 can realize the SES over PCIe service provided through a PCIe link, and at the same time, the application programs and drivers in the host 210 of the electronic device 200 can manage the chassis 100 through the SES service provided by the PCIe link.

In order to implement the SES over PCIe service, the PCIe switch 110 may provide a virtual endpoint 111 (EP) for an SES-based enclosure management function. Based on this virtual EP, the PCIe switch 110 can generate a management thread for receiving and processing management instructions sent by the host, including SES instructions.

The virtual endpoint 111 is a virtual function endpoint implemented inside the PCIe switch that can be discovered by the host 210 of the electronic device 200. The virtual endpoint 111 depends on hardware support to a certain extent, and can be used to implement a management function or an I/O function, and the management function may be an SES-based chassis 100 management function. The process of monitoring and managing the chassis 100 by the host 210 in the electronic device 200 is the data interaction process between the host 210 and the virtual endpoint 111. The PCIe switch 110 can include multiple virtual endpoints 111 for different functions.

In this embodiment, regarding the communication between the PCIe switch 110 and the host 210 of the electronic device 200, when the host 210 of the electronic device 200 starts, the virtual endpoint 111 in the PCIe switch 110 is discovered in a PCIe standard enumeration process, so that the host 210 sends the SES instruction to the virtual endpoint 111.

The electronic device 200 sends the SES instruction to the virtual endpoint 111, obtains the execution result of the SES instruction through the virtual endpoint 111, and monitors the chassis 100 according to the execution result; the electronic device 200 displays the execution result for monitoring the chassis 100.

Specifically, in this embodiment, the virtual endpoint 111 is configured in the PCIe switch 110, and is discovered during the PCIe standard enumeration process when the host 210 is started. The virtual endpoint 111 receives the SES instruction sent by the host 210 of the electronic device 200, and causes the firmware in the PCIe switch 110 to execute the SES instruction. After the firmware in the PCIe switch 110 generates an execution result according to the SES instruction, the virtual endpoint 111 feeds back the execution result to the host 210, so that the host 210 monitors the chassis 100 according to the execution result.

The virtual endpoint 111 is a firmware, which is a specific type of computer software that can provide low-level control for specific hardware of the device. The firmware can provide a standardized operating environment for more complex device software (allowing more hardware independence). Alternatively, for a less complex device, the firmware can act as a complete operating system, and perform all of the control, monitoring, and data processing functions. In this embodiment, the firmware refers to a functional unit virtualized by software running on the processors embedded in the PCIe switch, such as a real time operating system (RTOS), according to the PCIe standard protocol. The firmware is an accessible object abstracted to the host 210 of the electronic device 200 by the scheduled SES management program in the PCIe switch. The SES management thread is the final direct execution unit of the SES instruction, and the virtual endpoint 111 is a protocol window for interactive accessing and controlling by the SES management program in the PCIe switch and applications in the host 210 of the electronic device 200.

In this embodiment, the PCIe switch 110 executes the SES instruction through the management thread created by the firmware. After the firmware in the PCIe switch 110 generates the execution result according to the SES instruction, the virtual endpoint 111 sends an event notification for notifying that the execution result has been generated to the host 210. After receiving the event notification, the host 210 sends a read instruction to the virtual endpoint 111, and the virtual endpoint 111 feeds back the execution result of the firmware in the PCIe switch 110 to the host 210.

When the PCIe switch 110 receives the SES instruction, the firmware in the PCIe switch 110 executes the SES instruction to monitor the chassis 100. The SES instruction includes, but is not limited to, obtaining the status of the chassis 100 such as temperature, voltage, and fan status in the chassis 100, and may also include a control instruction to control the chassis 100, such as controlling the power on and off of the hard disk, and controlling the fan speed. That is to say, the user can transmit SES instructions to the PCIe switch 110 in the chassis 100 through applications and drivers of the host 210 of the electronic device 200 to monitor the status of components in the chassis 100, or control the chassis 100 and the components in the chassis 100.

Specifically, in this embodiment, the interaction process between the virtual endpoint 111 and the host 210 of the electronic device 200 through the PCIe link is as follows:

The host 210 of the electronic device 200 may transmit the SES instruction to the virtual endpoint 111 of the PCIe switch via the PCIe link through an application program and a driver. The PCIe switch creates one (or more) management thread by using the firmware to specifically process the management instructions (SES instructions or other management instructions such as Inquiry instructions, etc.) sent by the host. If the instruction sent by the host 210 of the electronic device 200 is an SES instruction, the management thread in the PCIe switch firmware will execute the SES instruction and save the execution result of the SES instruction in the PCIe switch, and then send an event notification for notifying the host of the electronic device 200 that data has been ready. Then the host 210 of the electronic device 200 transmits the read instruction to the virtual endpoint in the PCIe switch through the PCIe link, so as to read the execution result of the SES instruction saved in the PCIe switch. Finally, the execution result of the SES instruction, such as information relating to the status of the chassis 100 or fan control, will be displayed through the applications of the electronic device 200.

In addition, in this embodiment, the virtual endpoint 111 further receives a designated instruction sent by the host 210 to cause the firmware in the PCIe switch 110 to execute the designated instruction, and feeds back an execution result to the host 210 after the firmware in the PCIe switch 110 generates the execution result according to the designated instruction, so that the host 210 obtains designated information of the chassis or the PCIe switch according to the execution result.

That is, the host 210 of the electronic device 200 can also send other management instructions besides the SES instruction to the PCIe switch for viewing or monitoring other information besides the management of the chassis 100, such as special management information customized by the PCIe switch.

It can be seen from the above that the chassis monitoring system in this embodiment can transmit SES instruction to the PCIe switch in the chassis 100 via the PCIe link by using the electronic device 200 to monitor the chassis 100, so as to obtain the monitoring result. For monitoring the JBOF chassis 100 in which the PCIe switch is connected with a PCIe SSD, the management application based on the SES interface in the chassis 100 of the original host 210 can be partially used. In addition, the chassis monitoring system in this embodiment does not require additional baseboard management controller (BMC) to monitor the chassis 100, so it can reduce hardware costs, efficiently obtain complete information of chassis 100 and display the information on the application program of the device 200. The present embodiment only has to perform SES over PCIe services on the PCIe switch in the chassis 100, then complete SES service can be provided in any form of electronic device 200 (servers, personal computers, data centers, etc.), which greatly reduces the hardware cost for monitoring and managing the chassis, and greatly improved the efficiency and operation convenience of the chassis 100.

In addition, in order to highlight the innovative part of the present disclosure, technical features that are not closely related to solving the technical problems proposed by the present disclosure are not introduced in this embodiment, but this does not indicate that there are no alternative structures and features of this embodiment.

It should be noted that the illustrations provided in this embodiment only illustrate the basic idea of the present disclosure in a schematic manner. The figures only show the components related to the present disclosure, rather than the number, shape and size of the components in actual implementation. The type, number, and proportion of each component can be changed during actual implementation, and its component layout may also be more complicated.

### Embodiment 2

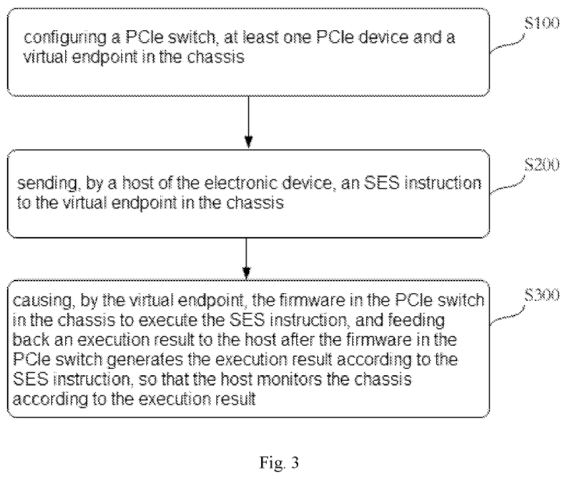

As shown in FIG. 3, this embodiment provides a chassis monitoring method, and the chassis monitoring method includes:

Step S100, configuring a PCIe switch, at least one PCIe device and a virtual endpoint in the chassis;

Step S200, sending, by a host of the electronic device, an SES instruction to the virtual endpoint in the chassis; and

Step S300, causing, by the virtual endpoint, the firmware in the PCIe switch in the chassis to execute the SES instruction, and feeding back an execution result to the host after the firmware in the PCIe switch generates the execution result according to the SES instruction, so that the host monitors the chassis according to the execution result.

The PCIe switch can be coupled with a PCIe device of any function. The PCIe device can be a PCIe SSD, a PCIe GPU card, a PCIe NIC card, or a PCIe switch.

In this embodiment, the PCIe switch includes a PCI-to-PCI Bridge (P2P) for connecting with an upstream port and a plurality of P2Ps for connecting with downstream ports. That is, the PCIe switch includes an upstream bridge port (P2P) for connecting with the host of the electronic device and at least one downstream bridge port (P2P) for connecting with the PCIe device.

In this embodiment, the upstream bridge port is connected with the host of the electronic device, and the downstream bridge port is connected with the PCIe device. When the PCIe device is a PCIe switch, the downstream port may also be used as an expansion port for cascading multiple PCIe switches, so as to obtain a larger PCIe topology structure. When the chassis of the PCIe switches are cascaded, the host of the electronic device needs sufficient memory resources.

The electronic device transmits SES instruction to the PCIe switch through the PCIe communication protocol, and the firmware in the PCIe switch executes the SES instruction to monitor the chassis. The PCIe switch transmits the execution result of the SES instruction to the electronic device.

In order to monitor the chassis by the electronic device, the PCIe switch can realize the SES over PCIe service provided through a PCIe link, and at the same time, the application programs and drivers in the host of the electronic device can manage the chassis through the SES service provided by the PCIe link.

In order to implement the SES over PCIe service, the PCIe switch may provide a virtual endpoint 111 (EP) for an SES-based enclosure management function. Based on this virtual EP, the PCIe switch can generate a management thread for receiving and processing management instructions sent by the host, including SES instructions.

The virtual endpoint is a virtual function endpoint implemented inside the PCIe switch that can be discovered by the host of the electronic device. The virtual endpoint depends on hardware support to a certain extent, and can be used to implement a management function or an I/O function, and the management function may be an SES-based chassis management function. The process of monitoring and managing the chassis by the host in the electronic device is the data interaction process between the host and the virtual endpoint. The PCIe switch can include multiple virtual endpoints for different functions.

In this embodiment, regarding the communication between the PCIe switch and the host of the electronic device, when the host of the electronic device starts, the virtual endpoint in the PCIe switch is discovered in a PCIe standard enumeration process, so that the host sends the SES instruction to the virtual endpoint.

The electronic device sends the SES instruction to the virtual endpoint, obtains the execution result of the SES instruction through the virtual endpoint, and monitors the chassis according to the execution result; the electronic device displays the execution result for monitoring the chassis.

Specifically, in this embodiment, the virtual endpoint is configured in the PCIe switch, and is discovered during the PCIe standard enumeration process when the host is started. The virtual endpoint receives the SES instruction sent by the host of the electronic device, and causes the firmware in the PCIe switch to execute the SES instruction. And after the firmware in the PCIe switch generates an execution result according to the SES instruction, the virtual endpoint feeds back the execution result to the host, so that the host monitors the chassis according to the execution result.

In this embodiment, the feeding back of the execution result to the host includes the following steps: after the firmware in the PCIe switch generates the execution result according to the SES instruction, the virtual endpoint sends an event notification for notifying that the execution result has been generated to the host; after receiving the event notification, the host sends a read instruction to the virtual endpoint; the virtual endpoint feeds back the execution result of the PCIe switch firmware to the host.

The virtual endpoint is a firmware, which is a specific type of computer software that can provide low-level control for specific hardware of the device. The firmware can provide a standardized operating environment for more complex device software (allowing more hardware independence). Alternatively, for a less complex device, the firmware can act as a complete operating system, and perform all of the control, monitoring, and data processing functions. In this embodiment, the firmware refers to a functional unit virtualized by software running on the processors embedded in the PCIe switch, such as a real time operating system (RTOS), according to the PCIe standard protocol. The firmware is an accessible object abstracted to the host of the electronic device by the scheduled SES management program in the PCIe switch. The SES management thread is the final direct execution unit of the SES instruction, and the virtual endpoint is a protocol window for interactive accessing and controlling by the SES management program in the PCIe switch and applications in the host of the electronic device.

When the PCIe switch receives the SES instruction, the firmware in the PCIe switch executes the SES instruction to monitor the chassis. The SES instruction includes, but is not limited to, obtaining the status of the chassis such as temperature, voltage, and fan status in the chassis, and may also include a control instruction to control the chassis, such as controlling the power on and off of the hard disk, and controlling the fan speed. That is to say, the user can transmit SES instructions to the PCIe switch in the chassis through applications and drivers of the host of the electronic device to monitor the status of components in the chassis, or control the chassis and the components in the chassis.

Specifically, in this embodiment, the interaction process between the virtual endpoint and the host of the electronic device through the PCIe link is as follows:

The host of the electronic device may transmit the SES instruction to the virtual endpoint of the PCIe switch via the PCIe link through an application program and a driver. The PCIe switch creates one (or more) management thread by using the firmware to specifically process the management instructions (SES instructions or other management instructions such as Inquiry instructions, etc.) sent by the host. If the instruction sent by the host of the electronic device is an SES instruction, the management thread in the PCIe switch firmware will execute the SES instruction and save the execution result of the SES instruction in the PCIe switch, and then send an event notification for notifying the host of the electronic device that data has been ready. Then the host of the electronic device transmits the read instruction to the virtual endpoint in the PCIe switch through the PCIe link, so as to read the execution result of the SES instruction saved in the PCIe switch. Finally, the execution result of the SES instruction, such as information relating to the status of the chassis or fan control, will be displayed through the applications of the electronic device.

In addition, in this embodiment, the virtual endpoint further receives a designated instruction sent by the host to cause the firmware in the PCIe switch to execute the designated instruction, and feeds back an execution result to the host after the firmware in the PCIe switch generates the execution result according to the designated instruction, so that the host obtains designated information of the chassis or the PCIe switch according to the execution result.

In other words, the host of the electronic device may also send other management instructions besides the SES instruction to the PCIe switch for viewing or monitoring other information besides chassis management, such as special management information customized by the PCIe switch.

In summary, in the present disclosure, a virtual EP is configured in the PCIe switch in the chassis. Based on this virtual EP, the electronic device transmits SES instructions to the PCIe switch in the chassis through the PCIe link to monitor the chassis and obtain the monitoring result. In addition, According to the present disclosure, as long as SES-over-PCIe services can be implemented on the firmware of PCIe switches, complete SES services can be provided in any form of electronic devices (servers, personal computers, data centers, etc.), which greatly reduces the hardware cost for monitoring and managing the chassis, and greatly improved the efficiency and operation convenience of the chassis. Therefore, the present disclosure effectively overcomes the defects in the prior art and has a high industrial value.

The above-mentioned embodiments only exemplarily illustrate the principles and effects of the present disclosure, and are not intended to limit the present disclosure. Anyone familiar with this technology can modify or change the above-mentioned embodiments without departing from the spirit and scope of the present disclosure. Therefore, all equivalent modifications or changes made by those with ordinary knowledge in the technical field without departing from the spirit and technical ideas disclosed by the present disclosure should still be covered by the claims of the present disclosure.

What is claimed is:

1. A chassis, communicating with an electronic device through a Peripheral Component Interconnect-Express (PCIe) link, wherein the chassis comprises:
at least one PCIe device;
a PCIe switch, including an upstream bridge port for connecting with a host of an electronic device and at least one downstream bridge port for connecting with the PCIe device; and
a virtual endpoint, configured in the PCIe switch, receiving an SCSI enclosure service (SES) instruction sent by the host, causing the firmware in the PCIe switch to execute the SES instruction, and feeding back an execution result to the host after the firmware in the PCIe switch generates an execution result according to the SES instruction, so that the host monitors the chassis according to the execution result.

2. The chassis according to claim 1, wherein after the firmware in the PCIe switch generates the execution result according to the SES instruction, the virtual endpoint sends an event notification for notifying that the execution result has been generated to the host, after receiving the event notification the host sends a read instruction to the virtual endpoint, and the virtual endpoint feeds back the execution result of the PCIe switch firmware to the host.

3. The chassis according to claim 1, wherein the PCIe switch executes the SES instruction through a management thread created by the firmware.

4. The chassis according to claim 1, wherein regarding the communication between the PCIe switch and the host, when the host of the electronic device starts, the virtual endpoint in the PCIe switch is discovered in a PCIe standard enumeration process, so that the host sends the SES instruction to the virtual endpoint.

5. The chassis according to claim 1, wherein the PCIe device includes a PCIe SSD, a PCIe GPU card, a PCIe NIC card, or a PCIe switch.

6. The chassis according to claim 1, wherein the virtual endpoint further receives a designated instruction sent by the host to cause the firmware in the PCIe switch to execute the designated instruction, and feeds back an execution result to the host after the firmware in the PCIe switch generates the execution result according to the designated instruction, so that the host obtains designated information of the chassis or the PCIe switch according to the execution result.

7. A chassis monitoring system, comprising:
a chassis according to claim 1; and
an electronic device, communicating with the chassis through a PCIe link, sending an SES instruction to the virtual endpoint, obtaining an execution result of the SES instruction through the virtual endpoint, and monitoring the chassis according to the execution result.

8. The chassis monitoring system according to claim 7, wherein the electronic device displays the execution result for monitoring the chassis.

9. A chassis monitoring method, comprising:
configuring a PCIe switch, at least one PCIe device, and a virtual endpoint in a chassis;
sending, by a host of an electronic device, an SES instruction to the virtual endpoint in the chassis; and
causing, by the virtual endpoint, the firmware in the PCIe switch in the chassis to execute the SES instruction, and feeding back an execution result to the host after the firmware in the PCIe switch generates the execution result according to the SES instruction, so that the host monitors the chassis according to the execution result.

10. The chassis monitoring method according to claim 9, wherein the feeding back of the execution result to the host comprises:
sending, by the virtual endpoint, an event notification for notifying that the execution result has been generated to the host after the firmware in the PCIe switch generates the execution result according to the SES instruction;
sending, by the host, a read instruction to the virtual endpoint after receiving the event notification; and
feeding back, by the virtual endpoint, the execution result of the PCIe switch firmware to the host.
